(19) United States
(12) Patent Application Publication
(10) Pub. No.: US 2010/0066909 A1
(43) Pub. Date: Mar. 18, 2010

(54) Video Processing Apparatus and Video Processing Method

(75) Inventors: Koji Miyazaki, Hamura-shi (JP); Shiro Kudo, Kumagaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/536,365

(22) Filed: Aug. 5, 2009

(30) Foreign Application Priority Data
Sep. 17, 2008 (JP) 2008-238334

(51) Int. Cl. H04N 9/74; H04N 5/50

(52) U.S. Cl. 348/581; 348/731; 348/E09.055; 348/E05.097

(57) ABSTRACT

According to one embodiment, a video processing apparatus includes a tuning module configured to tune a broadcast signal among input broadcast signals, a first video processing module configured to composite the video signal included in the tuned broadcast signal and a graphic, and to output a composite video signal and a second video processing module configured to convert a video size of the composite video signal into the video size of the video output device, and to output a size-converted composite video signal.

### CROSS-REFERENCE TO RELATED APPLICATIONS

This application is based upon and claims the benefit of priority from Japanese Patent Application No. 2008-238334, filed Sep. 17, 2008, the entire contents of which are incorporated herein by reference.

### BACKGROUND

1. Field

One embodiment of the present invention relates to a video processing apparatus and video processing method, which scale the resolution of a video signal included in a broadcast signal to that of a video display device such as a TV.

2. Description of the Related Art

In recent years, resolution-enhanced, large-size, low-profile displays are beginning to spread. For example, displays called full HD having a resolution of 1920×1080 are also beginning to prevail.

In contrast, video signals of digital television broadcasting include 480i, 480p, 1080i, and 720p signals. Furthermore, the 1080i signals include a signal having a resolution of 1920×1080 and that having a resolution of 1440×1080. The 1080i signal (resolution of 1920×1080) can be displayed intact on the full HD display (resolution of 1920×1080). The 480i signal (resolution of 720×480), 480p signal (resolution of 720×480), and 720p signal (resolution of 1280×720) can be displayed on the full HD display (resolution of 1920×1080) after they are stretched by up-scaling processing. Likewise, the 1080i signal (resolution of 1440×1080) can be displayed on the full HD display (resolution of 1920×1080) after it is stretched by scaling processing.

As is known, images such as characters are blurred by the aforementioned up-scaling processing. Jpn. Pat. Appln. KOKAI Publication No. 2008-28927 discloses a digital broadcast display apparatus which prevents such image blurring. For example, the digital broadcast display apparatus can separate a video/audio signal and a character/graphic signal included in digital broadcasting, and can output a composite signal the separated video/audio signal and the separated character/graphic signal or a composite signal of the separated video/audio signal and a character/graphic signal converted using a broadcast markup language (BML) from an external device. Since the character/graphic signal converted using the BML language can be composited to have an appropriate size on the digital TV receiver side, characters/graphics can be clearly displayed.

However, in order to appropriately execute the aforementioned scaling processing, the resolution of a video signal must be detected in advance. As a method of detecting the resolution of a video signal, a method of referring to event information (Event Information Table) included in a broadcast signal, and a method of decoding a video signal included in a broadcast signal are known.

With reference to the event information, the resolution of a video signal can be detected before the video signal is decoded. However, the event information includes information used to identify 480i, 480p, 720p, and 1080i signals, but it cannot specify the resolution of a 1080i signal.

By decoding a video signal, the resolution of the video signal can be precisely detected. However, the resolution cannot be recognized until decoding of the video signal is completed. For this reason, scaling processing corresponding to the resolution of the video signal cannot be executed before decoding of the video signal is completed.

For example, when the user selects a predetermined channel via a remote controller, since tuning of a broadcast signal and decoding of a video signal included in the broadcast signal require a certain period of time, a video of the predetermined channel cannot be displayed immediately. Hence, in order to notify the user that the predetermined channel is correctly tuned, tuning information including a service name and event name is displayed as a banner in response to the tuning operation of the predetermined channel. However, scaling processing corresponding to the resolution of a video signal cannot be executed before decoding of the video signal is completed, as described above. For this reason, a banner having an appropriate size cannot be displayed.

In this case, a banner having a temporary size is displayed temporarily, and is switched to that having an appropriate size after the scaling processing is ready to be executed. At this time, an image is disturbed due to the influence of the scaling processing. In order to cover up such image disturbance, a black-out frame is inserted at the banner display switching timing. As a result, the displayed banner unwantedly vanishes for an instant.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1A is a schematic block diagram showing the arrangement of a digital television broadcast receiver (video processing apparatus) according to an embodiment of the invention;

FIG. 1B is a block diagram for explaining video processing of a main and a backend processor of the digital television broadcast receiver in detail according to the embodiment;

FIG. 2 is a view showing images of input and output signals of the main and backend processors according to the embodiment;

FIG. 3 is a flowchart showing processing for executing scaling processing after a video signal is decoded according to the embodiment;

FIG. 4 is a flowchart showing processing for executing scaling processing in advance based on video resolution information included in event information according to the embodiment;

FIG. 5 is a flowchart showing an example of processing for executing scaling processing in advance based on video resolution information stored for respective pieces of service identification information according to the embodiment;

FIG. 6 is a flowchart showing processing for executing scaling processing in advance based on video resolution information included in event information and that stored for respective pieces of service identification information according to the embodiment;

FIG. 7A is a flowchart showing processing for executing scaling processing in advance based on video resolution information included in event information and that stored for some pieces of service identification information according to the embodiment;

FIG. 7B is a flowchart showing resolution confirmation processing according to the embodiment;

FIG. 7C is a flowchart showing update processing of resolution registration information according to the embodiment;

FIG. 8A is a reference drawing showing an example of video signal processing using one processor which does not execute super-resolution processing; and

FIG. 8B is a view showing video signal processing of the main and backend processors according to the embodiment.

### DETAILED DESCRIPTION

Various embodiments according to the invention will be described hereinafter with reference to the accompanying drawings. In general, a video processing apparatus according to one embodiment of the invention comprises: a storage module configured to store resolution registration information which associates service identification information with a resolution of a video signal provided by a broadcast signal corresponding to the service identification information, and to store a resolution of a video output device; an input module configured to input service identification information; a control module configured to predict a resolution of a video signal, provided by a broadcast signal corresponding to the input service identification information based on the resolution registration information, and to set scaling for converting a video size of the video signal into a video size of the video output device based on a difference between the predicted resolution of the video signal and the stored resolution of the video output device; a tuning module configured to tune a broadcast signal corresponding to the input service identification information among input broadcast signals; a first video processing module configured to composite the video signal included in the tuned broadcast signal and a graphic, and to output a composite video signal; and a second video processing module configured to convert a video size of the composite video signal into the video size of the video output device based on the scaling set by the control module, and to output a size-converted composite video signal.

Embodiments of the invention will be described hereinafter with reference to the drawings.

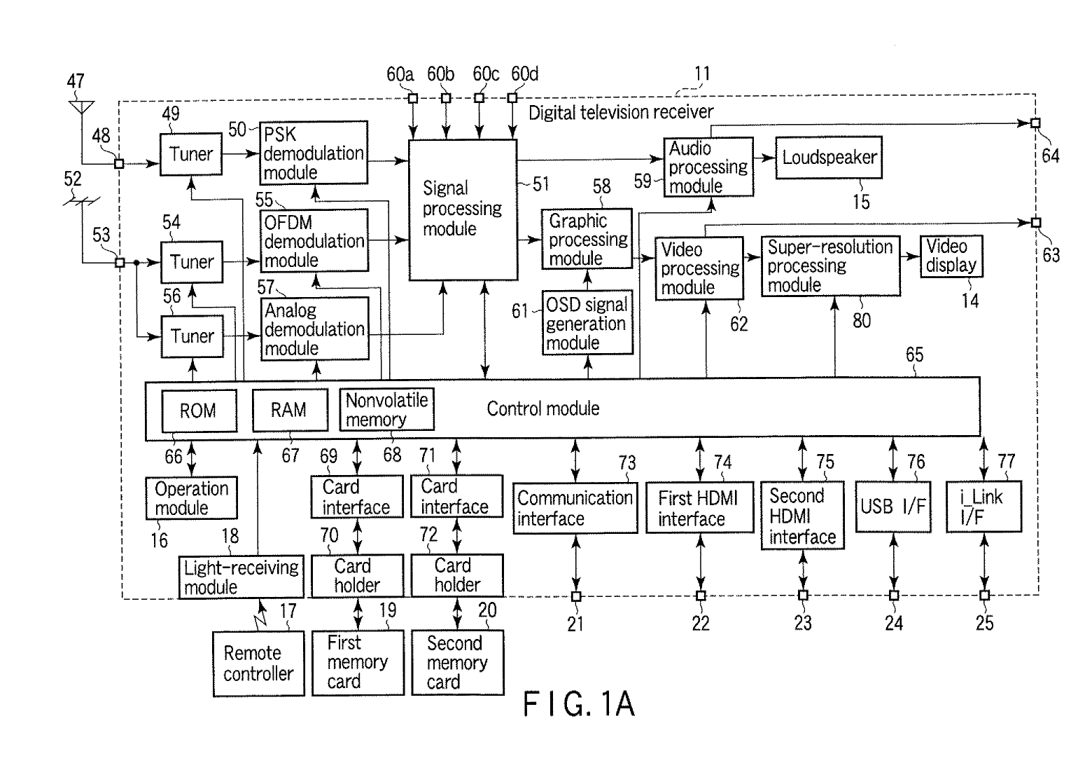

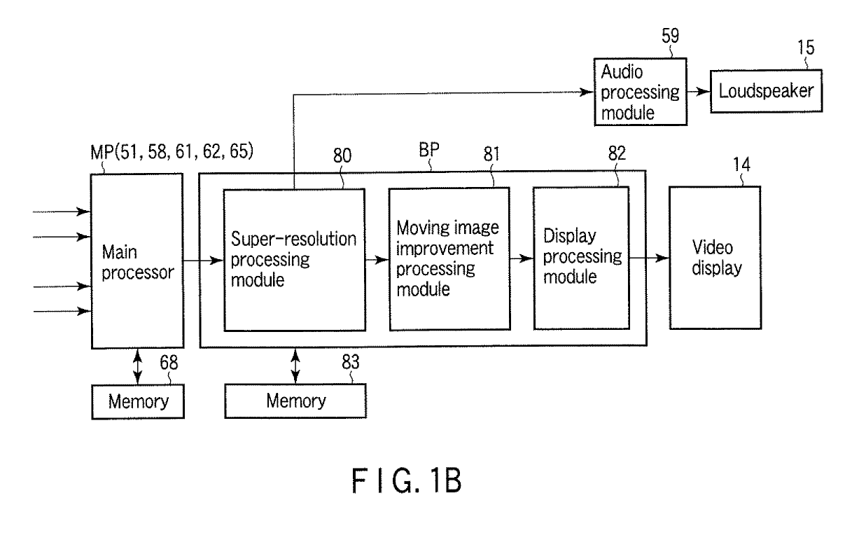

FIG. 1A is a schematic block diagram showing the arrangement of a digital television broadcast receiver (video processing apparatus) according to an embodiment of the invention, and FIG. 1B is a block diagram for explaining video processing in the digital television broadcast receiver in detail.

FIG. 1A shows a principal signal processing system of a digital television broadcast receiver 11 described above. That is, a satellite digital television broadcast signal received by a BS/CS digital broadcast receiving antenna 47 is supplied to a satellite digital broadcast tuner 49 via an input terminal 48, thus tuning a broadcast signal of a desired channel.

The broadcast signal tuned by this tuner 49 is supplied to a phase-shift keying (PSK) demodulation module 50, and is demodulated to digital video and audio signals. The demodulated digital video and audio signals are then output to a signal processing module 51.

A terrestrial digital television broadcast signal received by a terrestrial broadcast receiving antenna 52 is supplied to a terrestrial digital broadcast tuner 54 via an input terminal 53, thus tuning a broadcast signal of a desired channel.

The broadcast signal tuned by this tuner 54 is supplied to an orthogonal frequency division multiplexing (OFDM) demodulation module 55, and is demodulated to digital video and audio signals. The demodulated digital video and audio signals are then output to the signal processing module 51.

A terrestrial analog television broadcast signal received by the terrestrial broadcast receiving antenna 52 is supplied to a terrestrial analog broadcast tuner 56 via the input terminal 53, thus tuning a broadcast signal of a desired channel. The broadcast signal tuned to by this tuner 56 is supplied to an analog demodulation module 57, and is demodulated to analog video and audio signals. The demodulated analog video and audio signals are then output to the signal processing module 51.

The signal processing module 51 selectively applies predetermined digital signal processing to the digital video and audio signals supplied from the PSK demodulation module 50 and OFDM demodulation module 55, and outputs the processed digital video and audio signals to a graphic processing module 58 and audio processing module 59.

To the signal processing module 51, a plurality of (four in FIG. 1A) input terminals 60a, 60b, 60c, and 60d are connected. These input terminals 60a to 60d respectively allow to input analog video and audio signals from outside the digital television receiver 11.

The signal processing module 51 selectively converts analog video and audio signals supplied from the analog demodulation module 57 and the input terminals 60a to 60d into digital video and audio signals, applies predetermined digital signal processing to these digital video and audio signals, and outputs them to the graphic processing module 58 and audio processing module 59.

Of these modules, the graphic processing module 58 has a function of superimposing an on-screen display (OSD) signal generated by an OSD signal generation module 61 on the digital video signal supplied from the signal processing module 51, and outputting the superimposed signal. This graphic processing module 58 can selectively output the output video signal from the signal processing module 51 and the output OSD signal from the OSD signal generation module 61, or can combine both these outputs respectively form halves of the screen and can output the combined output.

The digital video signal output from the graphic processing module 58 is supplied to a video processing module 62. The video signal processed by the video processing module 62 is supplied to a super-resolution processing module 80. The video signal that has undergone super-resolution processing by the super-resolution processing module 80 is supplied to a video display 14, and also to an output terminal 63. The video display 14 displays a video based on the video signal. When an external device is connected to the output terminal 63, the video signal supplied to the output terminal 63 is input to that external device.

The audio processing module 59 converts the input digital audio signal into an analog audio signal in a format that can be played back by a loudspeakers 15, and outputs the analog audio signal to the loudspeakers 15 to make them play it back. Also, the audio processing module 59 externally outputs the analog audio signal via an output terminal 64.

Note that all the operations including the aforementioned various reception operations of this digital television receiver 11 are systematically controlled by a control module 65. This control module 65 incorporates a central processing unit (CPU) and the like, receives operation information from an operation module 16 or that output from a remote controller 17 via a light-receiving module 18, and controls respective modules to reflect the operation contents.

In this case, the control module 65 mainly uses a read-only memory (ROM) 66 that stores control program to be executed by its CPU, a random access memory (RAM) 67 that provides a work area to the CPU, and a nonvolatile memory 68 that stores various kinds of setting information and control information, and the like.

This control module 65 is connected to a card holder 70 to which a first memory card 19 is detachably attached via a card interface 69. As a result, the control module 65 can exchange information with the first memory card 19 attached to the card holder 70 via the card interface 69.

This control module 65 is connected to a card holder 72 to which a second memory card 20 is detachably attached via a card interface 71. As a result, the control module 65 can exchange information with the second memory card 20 attached to the card holder 72 via the card interface 71.

The control module 65 is connected to a LAN terminal 21 via a communication interface 73. The control module 65 can thus exchange information with a LAN-compatible device connected to the LAN terminal 21 via the communication interface 73. In this case, the control module 65 has a Dynamic Host Configuration Protocol (DHCP) server function, and controls the LAN-compatible device connected to the LAN terminal 21 by assigning an Internet Protocol (IP) address to it.

Furthermore, the control module 65 is connected to a first HDMI terminal 22 via a first HDMI interface 74. As a result, the control module 65 can exchange information with an HDMI-compatible device connected to the first HDMI terminal 22 via the first HDMI interface 74. Also, the control module 65 is connected to a second HDMI terminal 23 via a second HDMI interface 75. Hence, the control module 65 can exchange information with an HDMI-compatible device connected to the second HDMI terminal 23 via the second HDMI interface 75.

The control module 65 is connected to a USB terminal 24 via a USB interface 76. As a result, the control module 65 can exchange information with USB-compatible devices connected to the USB terminal 24 via the USB interface 76.

Moreover, the control module 65 is connected to an i.Link terminal 25 via an i.Link interface 77. As a consequence, the control module 65 can exchange information with i.Link-compatible devices connected the i.Link terminal 25 via the i.Link interface 77.

In this embodiment, the digital television broadcast receiver includes a main processor MP and a backend processor BP, as shown in FIG. 1B. The main processor MP shown in FIG. 1B corresponds to the signal processing module 51, graphic processing module 58, OSD signal generation module 61, video processing module 62, and control module 65 shown in FIG. 1A. The backend processor BP shown in FIG. 1B includes the super-resolution processing module 80, a moving image improvement processing module 81, and a display processing module 82. The backend processor BP can record information on a memory 83, and can read out information recorded on the memory 83. FIG. 1B shows the case in which the backend processor BP includes the super-resolution processing module 80, moving image improvement processing module 81, and display processing module 82. However, the moving image improvement processing module 81 and display processing module 82 may be arranged independently from the backend processor BP. The aforementioned backend processor BP (super-resolution processing module 80) executes super-resolution processing. The super-resolution processing implements up-conversion using a super-resolution algorithm, and converts, for example, the resolution of an SD video into a sharp HD resolution. In other words, the super-resolution processing interpolates missing luminance signals and estimates an optimal pixel array to generate a video.

The scaling processing of the main and backend processors MP and BP must be individually changed in accordance with the resolution of a video. As described above, with reference to event information included in a broadcast signal, a 480i, 480p, 1080i, or 720p video signal can be identified. However, as for a 1080i video signal, a resolution of 1920×1080 or 1440×1080 cannot be specified. In order to specify the resolution, a method of decoding a video signal is available. Thus, the resolution of the 1080i video signal cannot be detected unless this video signal is actually tuned and decoded. That is, the scaling processing of the main and backend processors MP and BP cannot be settled unless this video signal is decoded. For this reason, the scaling processing of the main and backend processors MP and BP is executed after completion of decoding of the video signal, and a video is then displayed. Therefore, a display of the video is slightly delayed.

When the user selects a predetermined channel via the remote controller 17, since tuning of a broadcast signal and decoding of a video signal included in the broadcast signal require certain time, a video of the predetermined channel cannot be immediately displayed. Hence, in order to notify the user that the predetermined channel is correctly tuned, tuning information including a service name and event name is displayed as a banner in response to the tuning operation of the predetermined channel. However, the scaling processing of the main and backend processors MP and BP cannot be executed before completion of decoding of the video signal, as described above. For this reason, a banner having an appropriate size cannot be displayed.

In this case, a banner having a temporary size is displayed temporarily, and is switched to that having an appropriate size after the scaling processing is ready to be executed. At this time, an image is disturbed due to the influence of the scaling processing. In order to cover up such image disturbance, a black-out frame is inserted at the banner display switching timing. As a result, the displayed banner unwantedly vanishes for an instant.

The digital television broadcast receiver of this embodiment can eliminate a delay of the video display and a trouble at the time of banner display as follows.

(1) The digital television broadcast receiver stores resolution registration information that associates respective pieces of service identification information with the resolutions of video signals provided by broadcast signals corresponding to the respective pieces of service identification information, and stores the resolution of the video display 14. Furthermore, the digital television broadcast receiver predicts the resolution of a video signal provided by a broadcast signal corresponding to input service identification information input by a tuning operation based on this resolution registration information. Moreover, the digital television broadcast receiver settles scaling processing for converting the predicted resolution into that of the video display 14 before decoding of the video signal. That is, the digital television broadcast receiver settles the scaling processing of the main and backend processors MP and BP before decoding of the video signal. In this manner, the video display delay upon tuning and the vanishing of the displayed banner of the tuning information for an instant can be eliminated.

(2) The digital television broadcast receiver predicts the resolution of a video signal provided by a broadcast signal corresponding to input service identification information input by a tuning operation based on the aforementioned resolution registration information and event information. That is, if a 480i or 480p video signal is recognized based on the event information, it can be predicted that the resolution of this video signal is 720×480. If a 720p video signal is recognized, it can be predicted that the resolution of this video signal is 1280×720. On the other hand, if a 1080i video signal is recognized based on the event information, it is predicted based on the resolution registration information whether the resolution of this video signal is 1280×720 or 1920×1080. Furthermore, the digital television broadcast receiver settles scaling processing for converting the predicted resolution into that of the video display 14 before decoding of the video signal. That is, the digital television broadcast receiver settles the scaling processing of the main and backend processors MP and BP before decoding of the video signal. In this manner, the video display delay upon tuning and the vanishing of the displayed banner of the tuning information for an instant can be eliminated.

(3) The digital television broadcast receiver stores resolution registration information which associates respective pieces of service identification information that provide 1080i video signals with the resolutions of video signals provided by broadcast signals corresponding to the respective pieces of service identification information, and stores the resolution of the video display 14. In this manner, the information volume of the resolution registration information to be stored is reduced. The digital television broadcast receiver predicts the resolution of a video signal provided by a broadcast signal corresponding to input service identification information input by a tuning operation based on the aforementioned resolution registration information and event information. That is, if a 480i or 480p video signal is recognized based on the event information, it can be predicted that the resolution of this video signal is 720×480. If a 720p video signal is recognized, it can be predicted that the resolution of this video signal is 1280×720. On the other hand, if a 1080i video signal is recognized based on the event information, it is predicted based on the resolution registration information whether the resolution of this video signal is 1280×720 or 1920×1080. Furthermore, the digital television broadcast receiver settles scaling processing for converting the predicted resolution into that of the video display 14 before decoding of the video signal. That is, the digital television broadcast receiver settles the scaling processing of the main and backend processors MP and BP before decoding of the video signal. In this manner, the video display delay upon tuning and the vanishing of the displayed banner of the tuning information for an instant can be eliminated.

(4) The digital television broadcast receiver stores resolution registration information (initial values) which associates respective pieces of service identification information with the resolutions of video signals provided by broadcast signals corresponding to the respective pieces of service identification information, and stores the resolution of the video display 14. Furthermore, the digital television broadcast receiver predicts the resolution of a video signal provided by a broadcast signal corresponding to input service identification information input by a tuning operation based on this resolution registration information. Moreover, the digital television broadcast receiver settles scaling processing for converting the predicted resolution into that of the video display 14 before decoding of the video signal. That is, the digital television broadcast receiver settles the scaling processing of the main and backend processors MP and BP before decoding of the video signal. Also, the digital television broadcast receiver updates the resolution registration information by the actual resolution of the video signal. For example, when the predicted resolution is different from the actual resolution, the resolution registration information is updated, thus improving the efficiency of the next scaling processing.

(5) As described above, the digital television broadcast receiver settles the scaling processing for converting the predicted resolution into that of the video display 14 and super-resolution processing before decoding of a video signal. That is, the digital television broadcast receiver settles the scaling processing and super-resolution processing of the main and backend processors MP and BP before decoding of the video signal. Note that processing other than the super-resolution processing can also be settled based on the predicted resolution.

The digital television broadcast receiver of this embodiment will be described in more detail below.

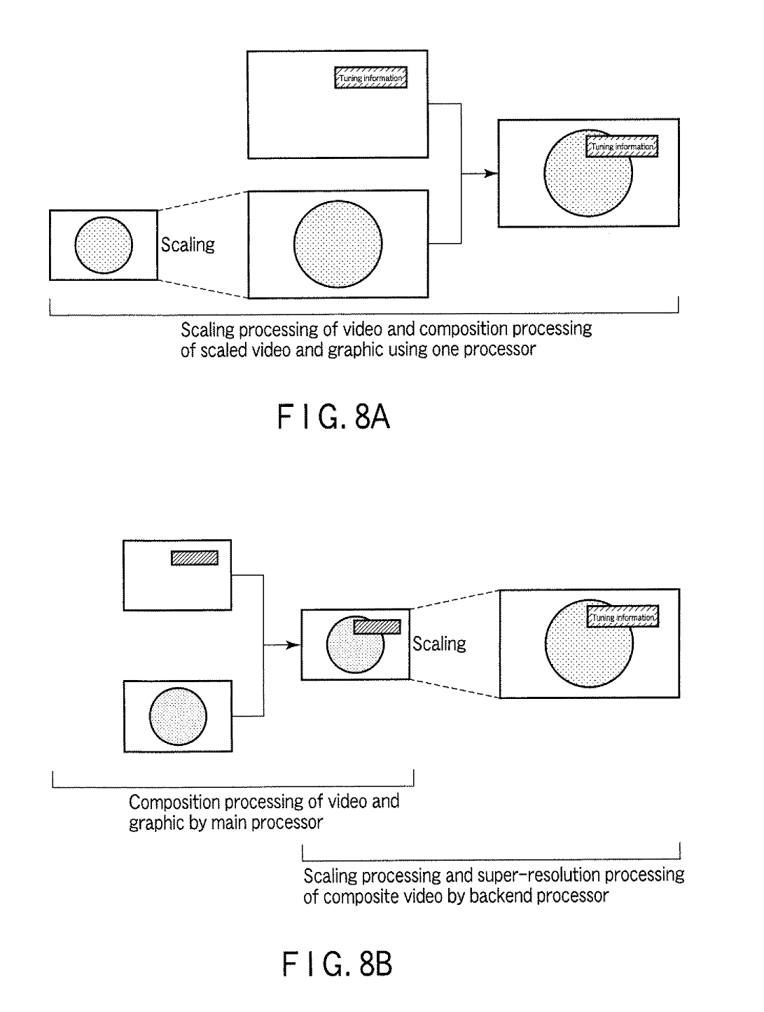

As described above, in the digital television broadcast receiver, the main processor MP processes a video signal (composition processing, etc.), and the backend processor BP then processes the video signal (scaling processing, super-resolution processing, etc.), as shown in FIG. 8B. Under the precondition that the video signal is to be processed, as described above, the main and backend processors MP and BP may be implemented using a single processor. Note that FIG. 8A is a reference drawing showing an example of video signal processing using one processor, which does not execute super-resolution processing. That is, one processor scales a video signal, and composites the scaled video with a graphic.

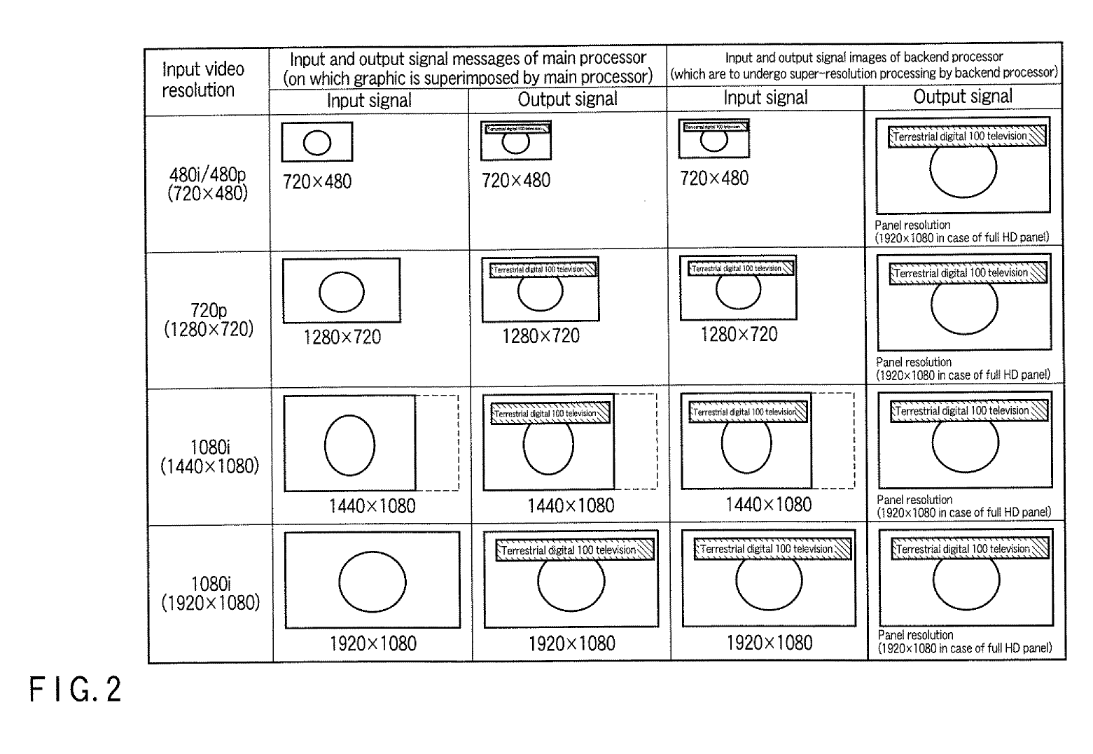

FIG. 2 is a view showing images of input and output signals of the main and backend processors MP and BP. The main processor MP executes video signal processing and graphic superimposition processing for respective input video resolutions. The backend processor BP scales the graphic-superimposed video signal output from the main processor MP in correspondence with the resolution (panel resolution) of the video display 14. As a part of this scaling processing, super-resolution processing is executed.

As can be seen from FIG. 2, a graphic size to be superimposed by the main processor MP and a scaling size to be executed by the backend processor BP change depending on the input video resolutions.

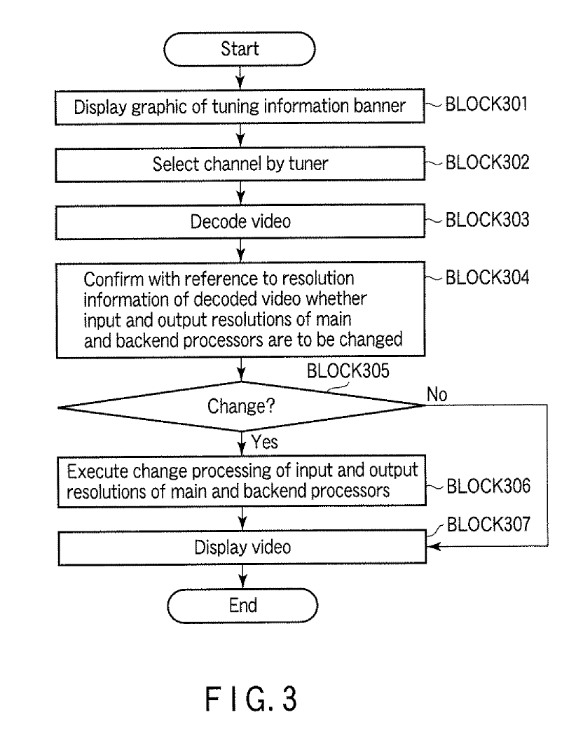

An example of processing for executing scaling processing after a video signal is decoded will be described below with reference to FIG. 3.

For example, when the user selects a predetermined channel via the remote controller 17, tuning information including a service name and event name displayed as a banner under the control of the main processor MP (BLOCK 301). Note that the banner having a temporary size is displayed in this case. Furthermore, the tuner 49, 54, or 56 tunes the predetermined channel in response to the tuning operation of the predetermined channel (BLOCK 302), and a video signal included in a broadcast signal of the tuned predetermined channel is decoded (BLOCK 303).

The main processor MP detects the resolution of the video signal based on the decoding result, and confirms based on this detected resolution whether the input and output resolutions of the main and backend processors MP and BP are to be changed (BLOCK 304). If the detected resolution of the video signal is different from the panel resolution (YES in BLOCK 305), the main processor MP changes the input and output resolutions of the main and backend processors MP and BP (BLOCK 306). For example, as shown in FIG. 2, when the resolution of the video signal is 720×480 and the panel resolution is 1920×1080, the resolution of the video signal output from the backend processor BP is changed to 1920×1080 with respect to the resolution of 720×480 of the video signal input to the main processor MP. Also, when the resolution of the video signal is 1280×720 and the panel resolution is 1920×1080, the resolution of the video signal output from the backend processor BP is changed to 1920×1080 with respect to the resolution of 1280×720 of the video signal input to the main processor MP. Furthermore, when the resolution of the video signal is 1440×1080 and the panel resolution is 1920×1080, the resolution of the video signal output from the backend processor BP is changed to 1920×1080 with respect to the resolution of 1440×1080 of the video signal input to the main processor MP. The video display 14 displays a video based on the video signal having the resolution which is changed in this way (BLOCK 307).

If the detected resolution of the video signal is equal to the panel resolution (NO in BLOCK 305), the main processor MP does not change the input and output resolutions of the main and backend processors MP and BP. For example, as shown in FIG. 2, when the resolution of the video signal is 1920×1080 and the panel resolution is also 1920×1080, the resolution of the video signal input to the main processor MP is 1920×1080, and that of the video signal output from the backend processor BP is also 1920×1080. The video display 14 displays a video based on the video signal output from the backend processor BP (BLOCK 307).

As described above, the scaling processing of the main and backend processors MP and BP cannot be settled until a channel tuning operation is executed and a video signal is decoded. For this reason, a video is displayed via the scaling processing of the main and backend processors MP and BP after the video signal is decoded. Hence, a display of the video is slightly delayed. When tuning information including a service name and event name is displayed as a banner before the video display, a banner having a temporary size is displayed initially, and is changed to that having an appropriate size after the scaling processing is executed, thus causing an image disturbance. In order to cover up such image disturbance, a black-out image must be inserted at the banner display switching timing. As a result, the displayed banner unwantedly vanishes for an instant.

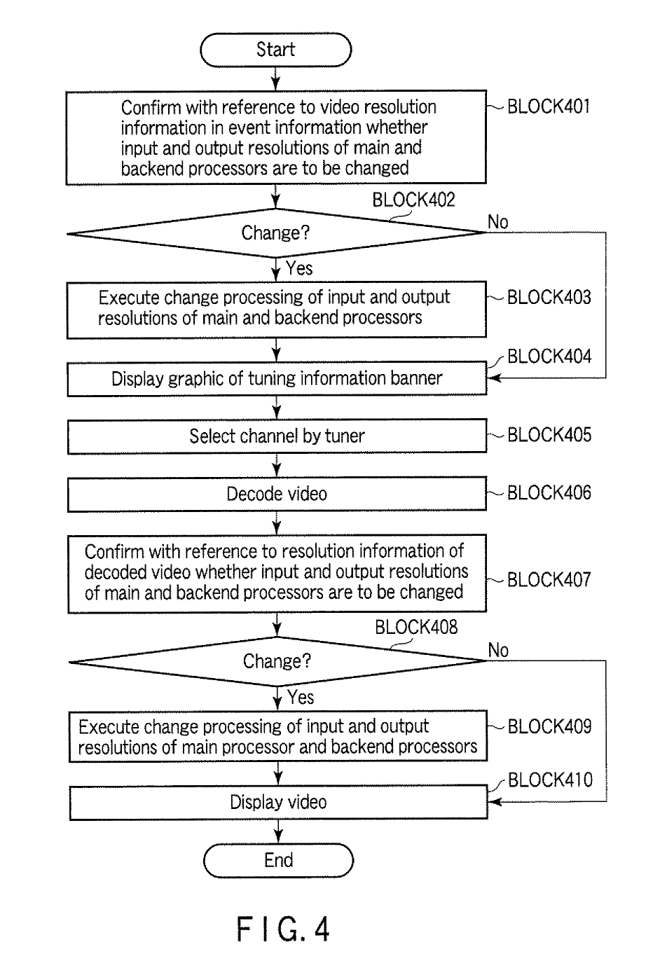

An example of processing for executing scaling processing in advance based on video resolution information included in event information will be described below with reference to FIG. 4.

For example, when the user selects a predetermined channel via the remote controller 17, the main processor HP predicts a video resolution of the predetermined channel with reference to video resolution information in event information, and confirms based on this predicted resolution whether the input and output resolutions of the main and backend processors MP and BP are to be changed (BLOCK 401). If the predicted resolution of the video signal is different from the panel resolution (YES in BLOCK 402), the main processor MP changes the input and output resolutions of the main and backend processors MP and BP (BLOCK 403). The practical example has already been described, and a repetitive description thereof will be avoided. If the predicted resolution of the video signal is equal to the panel resolution (NO in BLOCK 402), the main processor MP does not change the input and output resolutions of the main and backend processors MP and BP.

Tuning information including a service name and event name is displayed as a banner in response to the aforementioned tuning operation of the predetermined channel under the control of the main processor MP (BLOCK 404). In this case, since the scaling processing of the main and backend processors MP and BP has already been settled, a banner having an appropriate size is displayed. Therefore, the aforementioned image disturbance and vanishing of the displayed banner for an instant can be avoided. Furthermore, the tuner 49, 54, or 56 tunes the predetermined channel in response to the tuning operation of the predetermined channel (BLOCK 405), and a video signal included in a broadcast signal of the tuned predetermined channel is decoded (BLOCK 406).

The main processor MP detects the resolution of the video signal based on the decoding result, and confirms based on this detected resolution whether the input and output resolutions of the main and backend processors MP and BP are to be changed (BLOCK 407). If the aforementioned predicted resolution is correct, the predicted resolution matches the detected resolution. In this case, the resolution of the video signal output from the backend processor BP has already been controlled to match the panel resolution. Hence, the input and output resolutions of the main and backend processors MP and BP are not changed. The video display 14 displays a video based on the video signal output from the backend processor BP (BLOCK 410). If the predicted resolution is wrong, the predicted resolution does not match the detected resolution. Hence, the input and output resolutions of the main and backend processors MP and BP are changed (BLOCK 409). The practical example has already been described, and a repetitive description thereof will be avoided. The video display 14 displays a video based on the video signal output from the backend processor BP (BLOCK 410).

As described above, the scaling processing of the main and backend processors MP and BP can be settled in advance based on the video resolution information included in the event information. In this way, the video display delay upon tuning and vanishing (or disturbing) of the displayed banner of the tuning information for an instant can be eliminated. However, the decoded video size cannot be determined with reference to the event information. That is, whether a 1080i video signal is that having a resolution of 1920×1080i or that having a resolution of 1440×1080i cannot be discriminated even with reference to the event information. Hence, as for a 1080i video signal, the scaling processing is executed after the video signal is decoded, as shown in FIG. 3. In this case, after the video signal is decoded, a video is displayed via the scaling processing of the main and backend processors MP and HP. Hence, a video display is delayed slightly. When tuning information including a service name and event name is displayed as a banner before a video is displayed, an image disturbance occurs due to a change of scaling processing. In order to cover up this image disturbance, a black-out image must be inserted at the banner size change timing. As a result, the displayed banner vanishes for an instant.

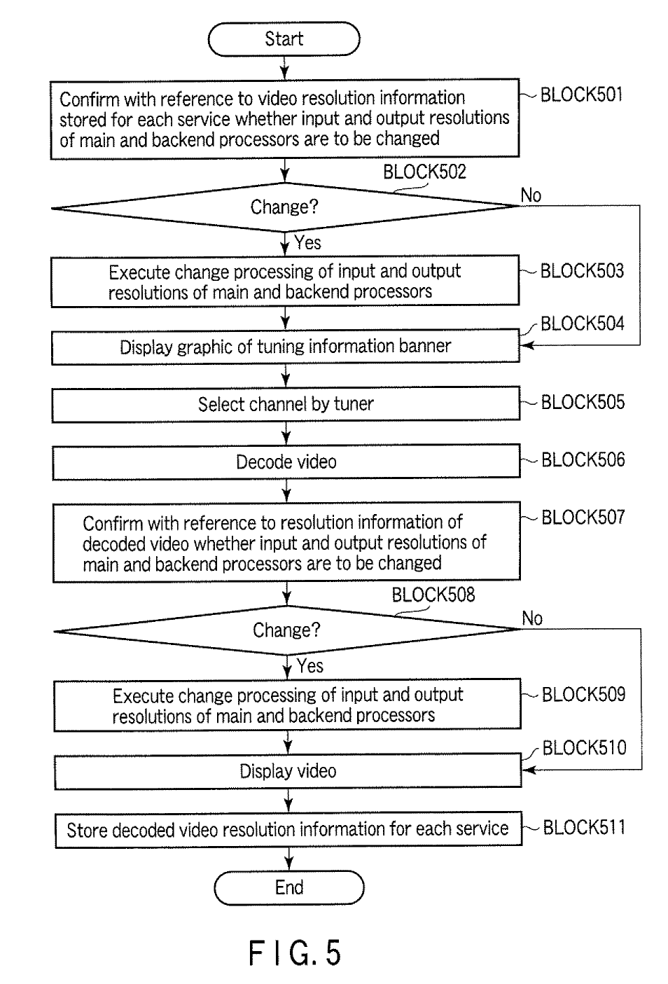

An example of processing for executing scaling processing in advance based on video resolution information stored for respective pieces of service identification information will be described below with reference to FIG. 5.

The digital television broadcast receiver for example, the nonvolatile memory 68) stores resolution registration information which associates respective pieces of service identification information with the resolutions of video signals provided by broadcast signals corresponding to the respective pieces of service identification information. For example, the resolution registration information includes information such as a terrestrial digital broadcast 101 channel: 1440×1080, a terrestrial digital broadcast 102 channel: 1440×1080, . . . , a BS digital broadcast 101 channel: 1920×1080, and a BS digital broadcast 102 channel: 1920×1080. The digital television broadcast receiver acquires the resolution registration information from broadcast signals or via the Internet.

For example, when the user selects a predetermined channel via the remote controller 17, the main processor MP predicts a video resolution of the predetermined channel with reference to the resolution registration information, and confirms based on this predicted resolution whether the input and output resolutions of the main and backend processors MP and BP are to be changed (BLOCK 501). If the predicted resolution of the video signal is different from the panel resolution (YES in BLOCK 502), the main processor MP changes the input and output resolutions of the main and backend processors MP and BP (BLOCK 503). The practical example has already been described, and a repetitive description thereof will be avoided. If the predicted resolution of the video signal is equal to the panel resolution (NO in BLOCK 502), the main processor MP does not change the input and output resolutions of the main and backend processors MP and BP.

Tuning information including a service name and event name is displayed as a banner in response to the tuning operation of the predetermined channel under the control of the main processor MP (BLOCK 504). In this case, since the scaling processing of the main and backend processors MP and BP has already been settled, a banner having an appropriate size is displayed. Therefore, the aforementioned image disturbance and vanishing of the displayed banner for an instant can be avoided. Furthermore, the tuner 49, 54, or 56 tunes the predetermined channel in response to the tuning operation of the predetermined channel (BLOCK 505), and a video signal included in a broadcast signal of the tuned predetermined channel is decoded (BLOCK 506).

The main processor MP detects the resolution of the video signal based on the decoding result, and confirms based on this detected resolution whether the input and output resolutions of the main and backend processors MP and BP are to be changed (BLOCK 507). If the aforementioned predicted resolution is correct, the predicted resolution matches the detected resolution. In this case, the resolution of the video signal output from the backend processor BP has already been controlled to match the panel resolution. Hence, the input and output resolutions of the main and backend processors MP and BP are not changed. The video display 14 displays a video based on the video signal output from the backend processor BP (BLOCK 510). If the predicted resolution is wrong, the predicted resolution does not match the detected resolution. Hence, the input and output resolutions of the main and backend processors MP and BP are changed (BLOCK 509). The practical example has already been described, and a repetitive description thereof will be avoided. The video display 14 displays a video based on the video signal output from the backend processor BP (BLOCK 510).

Furthermore, the main processor MP updates the resolution registration information based on the decoding result. For example, the main processor MP stores the service identification information and decoded video resolution information in association with each other (BLOCK 511). As a result, mismatching between the predicted resolution and detected resolution can be avoided from the next time, thus improving the efficiency of the scaling processing.

As described above, the scaling processing of the main and backend processors MP and BP can be settled in advance based on the resolution registration information. In this way, the video display delay upon tuning and vanishing (or disturbing) of the displayed banner of the tuning information for an instant can be eliminated. Also, since the scaling change processing after completion of decoding can be omitted, a video can be displayed slightly earlier.

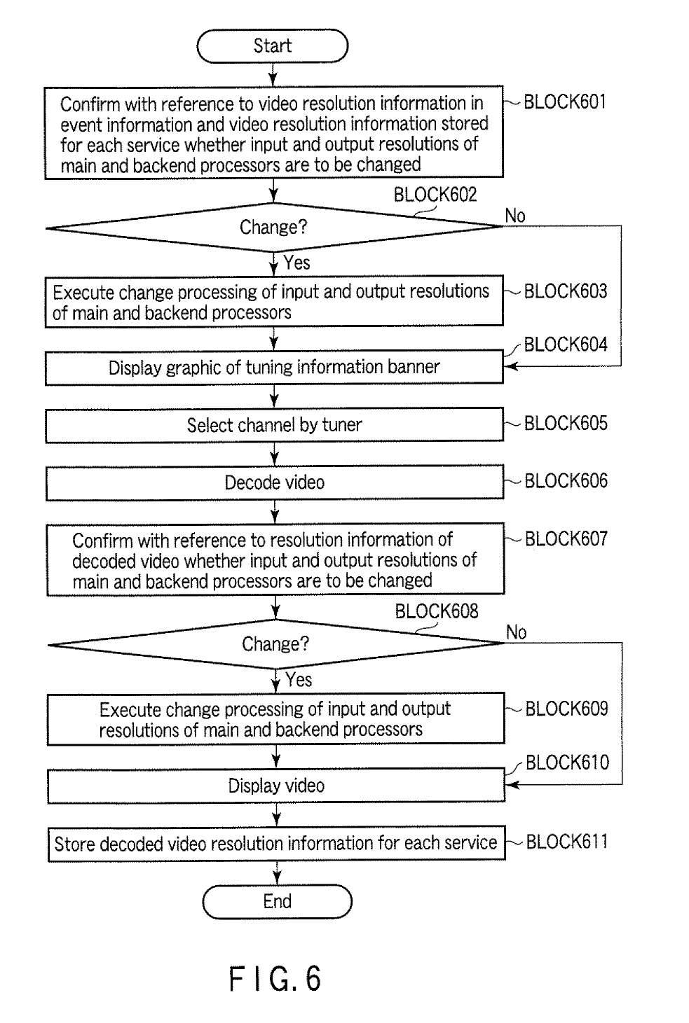

An example of processing for executing scaling processing in advance based on video resolution information included in event information and that stored for respective pieces of service identification information will be described below with reference to FIG. 6.

The resolution of a video signal broadcast in a certain service often changes depending time slots. In such case, when the resolution is predicted based on the resolution registration information, the predicted resolution is often different from an actual resolution. In this manner, a wrong resolution prediction may be made, and the scaling processing the main and backend processors MP and BP to be executed in advance may fail.

For example, a provider having a plurality of service (service identification information) may broadcast different SD resolution videos for respective service IDs and may broadcast an identical HD resolution video (multicasting) depending on time slots. The resolution of a video signal of such broadcasting changes depending on time slots. Hence, the resolution of a video signal cannot often be correctly predicted based only on the resolution registration information. In other words, the scaling processing of the main and backend processors MP and BP cannot be correctly predicted in advance.

When a wrong resolution prediction of a video signal is made, the scaling processing is consequently executed after the video signal is decoded, as shown in FIG. 3. In this case, after the video signal is decoded, a video is displayed via the scaling processing of the main and backend processors MP and BP. Hence, the video display is slightly delayed. When tuning information including a service name and event name is displayed as a banner before a video is displayed, an image disturbance occurs due to a change of scaling processing. In order to cover up this image disturbance, a black-out image is inserted at the banner display switching timing. As a result, a trouble (for example, vanishing of the displayed banner for an instant) occurs.

Hence, by executing advance scaling processing, as shown in FIG. 6, these troubles can be eliminated.

The digital television broadcast receiver (for example, the nonvolatile memory 68) stores resolution registration information which associates respective pieces of service identification information with the resolutions of video signals provided by broadcast signals corresponding to the respective pieces of service identification information. For example, the resolution registration information includes information such as a terrestrial digital broadcast 101 channel: 1440×1080, a terrestrial digital broadcast 102 channel: 1440×1080, . . . , a BS digital broadcast 101 channel: 1920×1080, and a BS digital broadcast 102 channel: 1920×1080. The digital television broadcast receiver acquires the resolution registration information from broadcast signals or via the Internet.

For example, when the user selects a predetermined channel via the remote controller 17, the main processor MP predicts a video resolution of the predetermined channel with reference to video resolution information included in event information and the resolution registration information, and confirms based on this predicted resolution whether the input and output resolutions of the main and backend processors MP and BP are to be changed (BLOCK 601).

For example, the main processor MP predicts the video resolution of the predetermined channel based on the video resolution information included in the event information. When the video resolution of the predetermined channel cannot be predicted based only on the video resolution information included in the event information, the main processor MP predicts the video resolution of the predetermined channel based on the resolution registration information. That is, whether a 1080i video signal is that having a resolution of 1920×1080 or a resolution of 1440×1080 cannot be specified. Hence, the video resolution of the 1080i video signal is predicted based on the resolution registration information.

If the predicted resolution of the video signal is different from the panel resolution (YES in BLOCK 602), the main processor MP changes the input and output resolutions of the main and backend processors MP and BP (BLOCK 603). The practical example has already been described, and a repetitive description thereof will be avoided. If the predicted resolution of the video signal is equal to the panel resolution (NO in BLOCK 602), the main processor MP does not change the input and output resolutions of the main and backend processors MP and BP.

Tuning information including a service name and event name is displayed as a banner in response to the tuning operation of the predetermined channel under the control of the main processor MP (BLOCK 604). In this case, since the scaling processing of the main and backend processors MP and BP has already been settled, a banner having an appropriate size is displayed. Therefore, the aforementioned image disturbance and vanishing of the displayed banner for an instant can be avoided. Furthermore, the tuner 49, 54, or 56 tunes the predetermined channel in response to the tuning operation of the predetermined channel (BLOCK 605), and a video signal included in a broadcast signal of the tuned predetermined channel is decoded (BLOCK 606).

The main processor MP detects the resolution of the video signal based on the decoding result, and confirms based on this detected resolution whether the input and output resolutions of the main and backend processors MP and BP are to be changed (BLOCK 607). If the aforementioned predicted resolution is correct, the predicted resolution matches the detected resolution. In this case, the resolution of the video signal output from the backend processor BP has already been controlled to match the panel resolution. Hence, the input and output resolutions of the main and backend processors MP and BP are not changed. The video display 14 displays a video based on the video signal output from the backend processor BP (BLOCK 610). If the predicted resolution is wrong, the predicted resolution does not match the detected resolution. Hence, the input and output resolutions of the main and backend processors MP and BP are changed (BLOCK 609). The practical example has already been described, and a repetitive description thereof will be avoided. The video display 14 displays a video based on the video signal output from the backend processor BP (BLOCK 610).

Furthermore, the main processor MP updates the resolution registration information based on the decoding result. For example, the main processor MP stores the service identification information and decoded video resolution information in association with each other (BLOCK 611). As a result, mismatching between the predicted resolution and detected resolution can be avoided from the next time, thus improving the efficiency of the scaling processing.

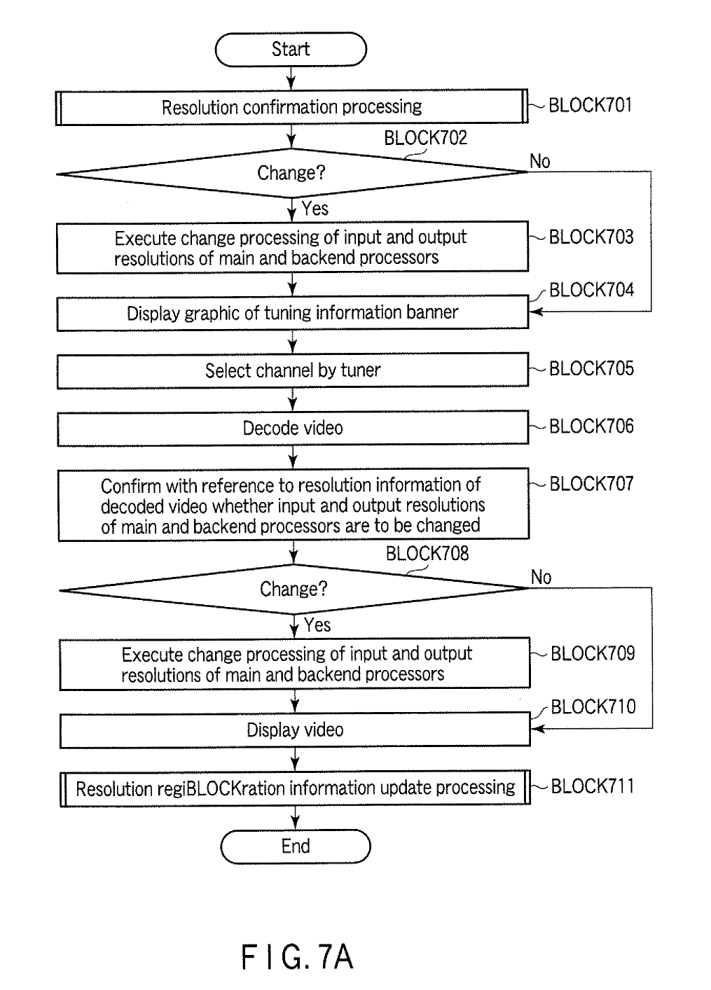

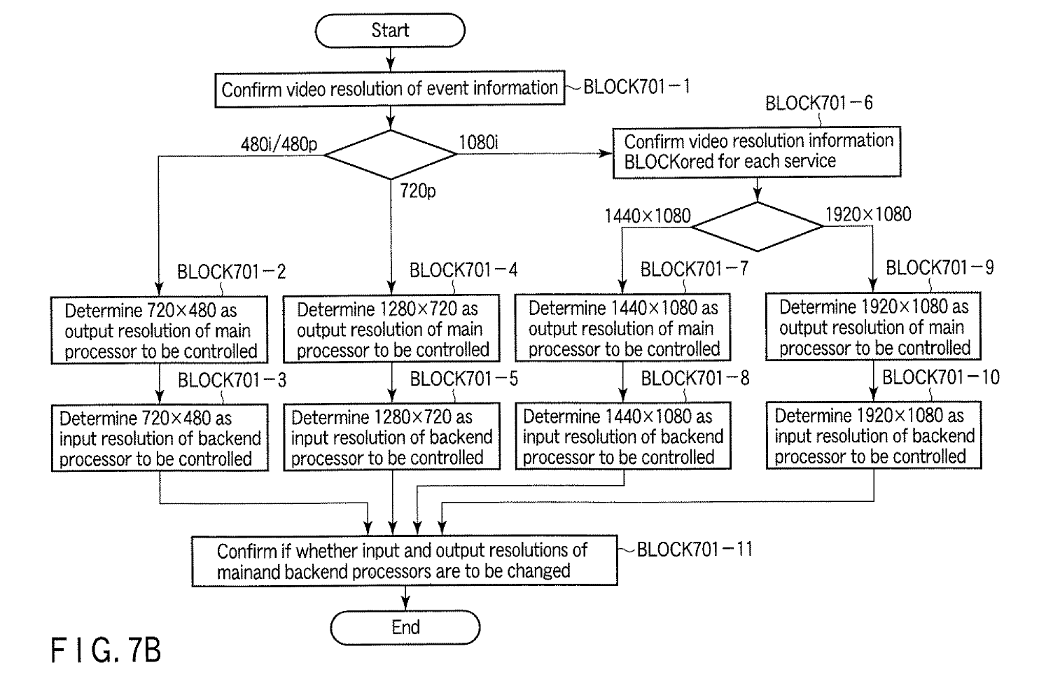

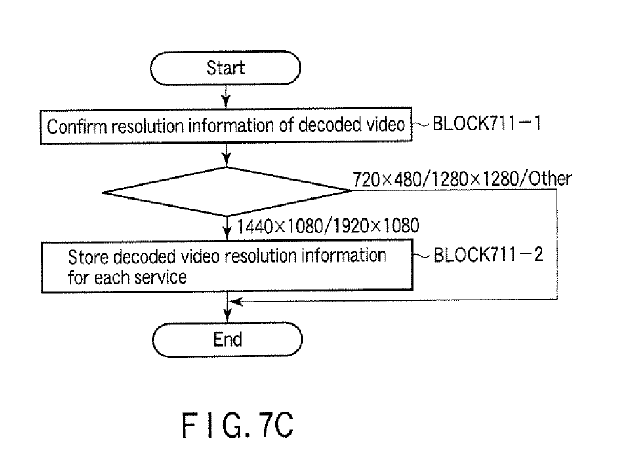

An example of processing for executing scaling processing in advance based on video resolution information included in event information and that stored for some pieces of service identification information will be described below with reference to FIGS. 7A to 7C. In this case, a case will be explained wherein only the resolutions of services that provide 1080i video signals are registered in place of the resolutions of all pieces of service identification information.

For example, when the user selects a predetermined channel via the remote controller 17, the main processor MP executes resolution confirmation processing (BLOCK 701). That is, the main processor MP predicts the video resolution of the predetermined channel with reference to video resolution information included in event information and resolution registration information, and confirms based on this predicted resolution whether the input and output resolutions of the main and backend processors NP and BP are to be changed. Initially, the main processor MP detects based on the video resolution information included in the event information whether the video type of the predetermined channel is one of 480i, 480p, 1080i, and 720p (BLOCK 701-1). If the video type of the predetermined channel is 480i or 480p, the main processor MP determines 720×480 as the output resolution of the main processor NP and the input resolution of the backend processor BP (BLOCK 701-2 and BLOCK 701-3). If the video type of the predetermined channel is 720p, the main processor MP determines 1280×720 as the output resolution of the main processor MP and the input resolution of the backend processor BP (BLOCK 701-4 and BLOCK 701-5). If the video type of the predetermined channel is 1080i, the main processor MP determines the output resolution of the main processor MP and the input resolution of the backend processor BP based on the resolution registration information (BLOCK 701-6). If the resolution of a video signal of the predetermined channel is 1440×1080, the main processor MP determines 1440×1080 as the output resolution of the main processor MP and the input resolution of the backend processor BP (BLOCK 701-7 and BLOCK 701-8). If the resolution of a video signal of the predetermined channel is 1920×1080, the main processor MP determines 1920×1080 as the output resolution of the main processor MP and the input resolution of the backend processor BP (BLOCK 701-9 and BLOCK 701-10).

After the output resolution of the main processor MP and the input resolution of the backend processor BP, which are to be controlled, are determined, the main processor MP confirms whether the input and output resolutions of the main and backend processors MP and BP are to be changed (BLOCK 701-11). If the input and output resolutions are to be changed (YES in BLOCK 702), the main processor MP executes change processing of the input and output resolutions of the main and backend processors MP and BP (BLOCK 703).

Tuning information including a service name and event name is displayed as a banner in response the tuning operation of the predetermined channel under the control of the main processor MP (BLOCK 704). In this case, since the scaling processing of the main and backend processors MP and BP has already been settled, a banner having an appropriate size is displayed. Therefore, the aforementioned image disturbance and vanishing of the displayed banner for an instant can be avoided. Furthermore, the tuner 49, 54, or 56 tunes the predetermined channel in response to the tuning operation of the predetermined channel (BLOCK 705), and a video signal included in a broadcast signal of the tuned predetermined channel is decoded (BLOCK 706).

The main processor MP detects the resolution of the video signal based on the decoding result, and confirms based on this detected resolution whether the input and output resolutions of the main and backend processors MP and BP are to be changed (BLOCK 707). If the input and output resolutions are not to be changed, the video display 14 displays a video based on the video signal output from the backend processor BP (BLOCK 710). If the input and output resolutions are to be changed, the main processor MP changes the input and output resolutions of the main and backend processors MP and BP (BLOCK 709), and the video display 14 displays a video based on the video signal output from the backend processor BP (BLOCK 710). For example, in case of a service which has never been tuned before, or when the resolution of a 1080i video signal has changed (1920×1080<=>1440×1080), the input and output resolutions of the main and backend processors MP and BP may be changed.

Furthermore, the main processor MP updates the resolution registration information based on the decoding result (BLOCK 711). For example, only when the resolution of a decoded video is 1920×1080 or 1440×1080 of a 1080i-based signal, the main processor MP records the service identification information and decoded video resolution information in association with each other (BLOCK 711-1 and BLOCK 711-2). In order to reduce the information volume, when the resolution of a decoded video is other than 1920×1080 or 1440×1080 of a 1080i-based signal, the main processor MP does not record the service identification information and decoded video resolution information in association with each other. As a result, the information volume of the resolution registration information can be reduced.

As described above, since the resolution registration information is updated in correspondence with decoding of video data, and includes the latest resolution information, the resolution can be predicted with high precision before video data is decoded, and the scaling processing of the main and backend processors MP and BP can be settled in advance. In addition, since the resolution registration information includes resolution information (initial values) prepared in advance, even when a channel which has never been tuned before is tuned, the resolution can be predicted relatively precisely before video data is decoded, and the scaling processing of the main and backend processors MP and BP can be settled in advance. In this way, the video display delay upon tuning and vanishing (or disturbing) of the displayed banner of the tuning information for an instant can be eliminated.

As described above, the digital television broadcast receiver of this embodiment can eliminate the video display delay upon tuning and vanishing (or disturbing) of the displayed banner of the tuning information for an instant. Also, since the scaling change processing after completion of decoding can be omitted, a video can be displayed slightly earlier.

The digital television broadcast receiver predicts the resolution of a video based on video resolution information included in event information. When the resolution of a video cannot be predicted based only on the video resolution information included in the event information, the digital television broadcast receiver predicts the resolution of a video based on resolution registration information. In this way, even when the resolution of a video broadcast in a certain service changes depending on time slots, the resolution of the video can be predicted relatively precisely, and the scaling processing of the main and backend processors MP and PP can be settled in advance.

Only when the decoded video resolution is a specific resolution, the digital television broadcast receiver records service identification information and this specific decoded video resolution information in association with each other. In this manner, the information volume can be reduced.

The various modules of the device described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video processing apparatus comprising:
a storage module configured to store resolution registration information which associates service identification information with a resolution of a video signal provided by a broadcast signal corresponding to the service identification information, and to store a resolution of a video output device;
an input module configured to input service identification information;
a control module configured to predict resolution of a video signal provided by a broadcast signal corresponding to the input service identification information based on the resolution registration information, and to set scaling for converting a video size of the video signal into a video size of the video output device based on a difference between the predicted resolution of the video signal and the stored resolution of the video output device;
a tuning module configured to tune a broadcast signal corresponding to the input service identification information among input broadcast signals;
a first video processing module configured to composite the video signal included in the tuned broadcast signal and a graphic, and to output a composite video signal; and
a second video processing module configured to convert a video size of the composite video signal into the video size of the video output device based on the scaling set by the control module, and to output a size-converted composite video signal.

2. The apparatus of claim 1, wherein the first video processing module is configured to output the graphic corresponding to the input service identification information at an input timing of the input service identification information, and
the second video processing module is configured to convert a video size of the graphic into the video size of the video output device based on the scaling set by the control module, and output a size-converted graphic.

3. The apparatus of claim 2, wherein the tuning module is configured to begin a tuning operation at the input timing of the input service identification information, and tune a broadcast signal corresponding to the input service identification information,
the first video processing module is configured to composite the video signal included in the tuned broadcast signal and the graphic after the graphic is output, and output the composite video signal, and
the second video processing module is configured to convert the video size of the composite video signal into the video size of the video output device based on the scaling set by the control module after the size-converted graphic is output, and output the size-converted composite video signal.

4. The apparatus of claim 1, wherein the first video processing module is configured to decode the video signal included in the tuned broadcast signal,
when an actual resolution of the video signal recognized by decoding of the video signal does not match the predicted resolution of the video signal, the control module is configured to re-set scaling for converting the video size of the video signal into the video size of the video output device based on a difference between the actual resolution of the video signal and the resolution of the video output device stored in the storage module, and
the second video processing module is configured to convert the video size of the composite video signal into the video size of the video output device based on the scaling re-set by the control module, and output a size-converted composite video signal.

5. The apparatus of claim 1, wherein the control module updates the resolution registration information based on an actual resolution of the video signal.

6. The apparatus of claim 1, wherein the control module is configured to predict a resolution of a video signal provided by a broadcast signal corresponding to the input service identification information based on at least one of the resolution registration information stored in the storage module and resolution information included in the input broadcast signal.

7. The apparatus of claim 1, wherein the control module is configured to predict a type and a resolution of a video signal provided by a broadcast signal corresponding to the input service identification information based on resolution information included in the input broadcast signal, and when a predetermined type is predicted and a resolution is not specified, the control module is configured to predict the resolution of the video signal, which is predicted to have the predetermined type, based on the resolution registration information.

8. A video processing method comprising:
storing resolution registration information which associates service identification information with a resolution of a video signal provided by a broadcast signal corresponding to the service identification information, and storing a resolution of a video output device;
inputting service identification information;
predicting a resolution of a video signal provided by a broadcast signal corresponding to the input service identification information based on the resolution registration information, and setting scaling for converting a video size of the video signal into a video size of the video output device based on a difference between the predicted resolution of the video signal and the stored resolution of the video output device;
tuning a broadcast signal corresponding to the input service identification information among input broadcast signals;
compositing the video signal included in the tuned broadcast signal and a graphic, and outputting a composite video signal; and
converting a video size of the composite video signal into the video size of the video output device based on the set scaling, and outputting a size-converted composite video signal.
